(19) United States
(12) Patent Application Publication
(10) Pub. No.: US 2025/0287075 A1
(43) Pub. Date: Sep. 11, 2025

(54) SEAMLESS PAUSEADS EXPERIENCE USING SINGLE PLAYER INSTANCE

(71) Applicant: DISH Network Technologies India Private Limited, Bengaluru (IN)

(72) Inventors: Yatindra Salian, Bangalore (IN); Nitin Gupta, Bangalore (IN); Sagar Sehgal, Bengaluru (IN); Lohit Huddar, Bengaluru (IN); Chinmay Hegde, Bengaluru (IN); Ankit Anand, Bangalore (IN); Kaustubh Dandekar, Nagpur (IN); Varun Sharma, Bangalore (IN)

(21) Appl. No.: 18/597,313

(22) Filed: Mar. 6, 2024

(51) Int. Cl. H04N 21/81; H04L 65/1069; H04N 21/239; H04N 21/262; H04N 21/431; H04N 21/433; H04N 21/858

(52) U.S. Cl. CPC H04N 21/812; H04L 65/1069; H04N 21/2393; H04N 21/262; H04N 21/431; H04N 21/4333; H04N 21/858

(57) ABSTRACT

The present disclosure provides systems, devices, and methods related to providing PauseAd services. An example method includes: sending a content manifest request for a content item to a content provider, receiving a content manifest response including a content manifest file associated with the content item and an advertisement (Ad) template, initiating a single player instance for playback and presentation of main content of the content item, pausing the playback of the main content in response to a user request, receiving a thumbnail image of the main content at pause, presenting the thumbnail image within the single player instance, sending an Ad manifest request for a PauseAd to a dynamic manifest generator, receiving an Ad manifest response, fetching the PauseAd, and initiating a PauseAd streaming session for playback of the PauseAd within the single player instance according to the Ad template and the Ad manifest file.

### BACKGROUND

In the context of digital content service and consumption, “PauseAds” refer to succinct and non-intrusive advertisements that are displayed when a viewer pauses the ongoing main content, such as a video or audio stream. This advertising format is triggered by a viewer interaction event to provide an opportunity for advertisers to engage with the viewer during an interruption in the flow of main content. PauseAds Typically appear as overlays on the paused screen and can provide advertisers a means to convey brand messages, promote products, or deliver targeted content through the advertisement.

Nevertheless, a significant challenge arises during transitions between PauseAds and the main content, resulting in disruptions such as black screens or buffering indicators. These interruptions can detract from viewer satisfaction and disrupt the smooth flow of content consumption. Therefore, there is a recognized need for an improvement in the transitions between PauseAds and main content to mitigate disruptions and enhance the overall viewing experience for viewers.

### SUMMARY

In accordance with some embodiments of the present disclosure, a method is provided. The method may be computer-implemented. In one example, a method includes: sending a content manifest request for a content item to a content provider in communication with the user device, receiving a content manifest response including a content manifest file associated with the content item and an advertisement (Ad) template, initiating a single player instance for playback and presentation of main content of the content item according to the content manifest file, pausing the playback of the main content at a first time point in response to a user request received in the user device, receiving a thumbnail image of the main content presented at the first time point, presenting the thumbnail image within the single player instance, sending an Ad manifest request for a PauseAd to a dynamic manifest generator in communication with the user device, receiving an Ad manifest response including an Ad manifest file and an Ad Uniform Resource Locator (URL) to the PauseAd, fetching the PauseAd using the Ad URL, and initiating a PauseAd streaming session for playback of the PauseAd within the single player instance, according to the Ad template and the Ad manifest file.

In accordance with some embodiments of the present disclosure, a user device is provided. In one example, the user device includes: one or more processors and a computer-readable storage media storing computer-executable instructions. The computer-executable instructions, when executed by the one or more processors, cause the user device to perform: sending a content manifest request for a content item to a content provider in communication with the user device, receiving a content manifest response including a content manifest file associated with the content item and an advertisement (Ad) template, initiating a single player instance for playback and presentation of main content of the content item according to the content manifest file, pausing the playback of the main content at a first time point in response to a user request received in the user device, receiving a thumbnail image of the main content presented at the first time point, presenting the thumbnail image within the single player instance, sending an Ad manifest request for a PauseAd to a dynamic manifest generator in communication with the user device, receiving an Ad manifest response including an Ad manifest file and an Ad Uniform Resource Locator (URL) to the PauseAd, fetching the PauseAd using the Ad URL, and initiating a PauseAd streaming session for playback of the PauseAd within the single player instance, according to the Ad template and the Ad manifest file.

In accordance with some embodiments of the present disclosure, a system is provided. In one example, the system includes: a user device, a dynamic manifest generator, an Ad template generator, and a thumbnail image generator. The dynamic manifest generator is configured to generate content manifest file and/or Ad manifest file in response to a manifest request, the Ad template generator is configured to generate an Ad template in response to a request, the thumbnail image generator is configured to generate a thumbnail image in response to a request. The user device is configured to: send a content manifest request for a content item to the dynamic manifest generator, receive a content manifest response generated by the dynamic manifest generator and an Ad template generated by the Ad template generator, wherein the content manifest response includes a content manifest file associated with the content item, initiate a single player instance for playback and presentation of main content of the content item according to the content manifest file, pause the playback of the main content at a first time point, in response to a user request received in the user device, receive a thumbnail image generated by the thumbnail image generator, the thumbnail image representing the main content presented at the first time point, present the thumbnail image within the single player instance, send an Ad manifest request for a PauseAd to the Ad manifest generator, receive an Ad manifest response generated by the Ad manifest generator, the Ad manifest response including an Ad manifest file and an Ad URL to the PauseAd, fetch the PauseAd using the Ad URL, and initiate a PauseAd streaming session for playback of the PauseAd within the single player instance, according to the Ad template and the Ad manifest file.

In accordance with some embodiments, the present disclosure also provides a non-transitory machine-readable storage medium encoded with instructions, the instructions executable to cause one or more electronic processors of a computer system or computer device to perform any one of the methods described in the present disclosure.

### BRIEF DESCRIPTION OF THE DRAWINGS

FIG. 1 is a block diagram illustrating an example communications system for providing PauseAd service, according to various embodiments of the present disclosure.

FIGS. 2A-2C are message flow diagrams respectively illustrating examples of interaction among components in the communications system of FIG. 1, according to various embodiments of the present disclosure.

FIGS. 3A-3D are a flow diagrams respectively illustrating example methods for providing PauseAd service, according to various embodiments of the present disclosure.

FIG. 4 illustrates an example computer system or computer device, according to various embodiments of the present disclosure.

### DETAILED DESCRIPTION

The present disclosure provides systems, devices, and methods generally related to providing media services, and more particularly, to providing PauseAd service.

Currently, many digital service platforms do not support the use of multiple player instances for providing media content streaming services. This constraint necessitates the implementation of a single player instance for both PauseAds and main content playback. However, a drawback arises during the transition between PauseAds and main content due to the utilization of different manifest URLs for these distinct content types. This results in a disruption such as a black screen or buffering indicator, indicating that the player is experiencing a delay in fetching or transitioning between the PauseAd and main content manifest URLs. The black screen or buffering indicator can be an undesirable user experience.

The present disclosure provides solutions to the above-mentioned challenges. One insight provided in the present disclosure is related to the implementation of dynamic Ad manifest generation and thumbnail images to facilitate smooth transitions between playback of PauseAd and main content within a single player instance. When a user pauses playback of main content on a user device, the user device may automatically pre-fetch of a thumbnail image of the main content at the paused content and display the thumbnail image during the transition process. The integration of thumbnail images during pauses in the player instance serves as a visual anchor for users and prevents interruptions like black screens or buffering indicators. This proactive approach of pre-fetching and displaying thumbnail images contributes to a seamless and visually appealing transition experience. Moreover, the utilization of dynamic Ad manifests further enhances the transition process. The real-time generation of Ad manifest data allows for flexibility and adaptability to diverse PauseAd scenarios. The transitions between PauseAds and the main content can be smooth and responsive to the user interaction event, which enhances the overall viewing experience on the user device.

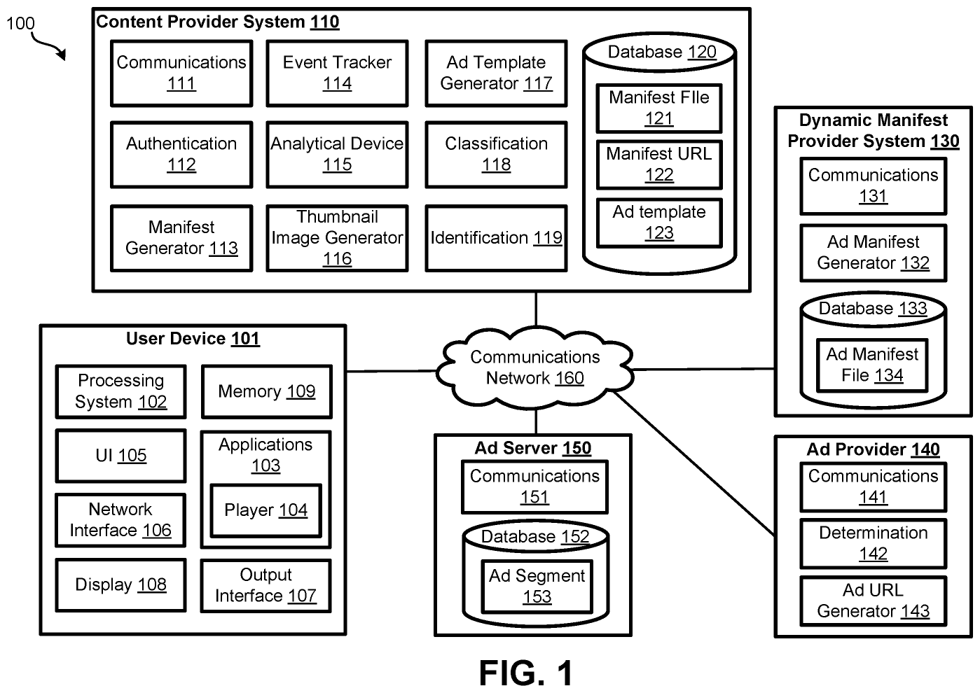

FIG. 1 is a block diagram illustrating an example communications system 100A for providing media content and PauseAd services. In the illustrated example, communications system 100 includes, among other components, user device 101, content provider system 110, dynamic manifest provider system (DMPS) 130, Ad provider 140, Ad server 150, and communications network 160. Each component included in the communications system 100 may be a hardware piece such as a server, a software piece such as a service, a cloud-based service, and an application, or a combination of hardware and software. Additional or fewer components may be included in the communications system 100.

The user device 101 may be a computerized device such as a smartphone, tablet, computer, smart TV, etc. In some embodiments, the user device 101 includes, among other components, processing system 102, applications (e.g., “apps”) 103, user interface (UI) 105, network interface 106, output interface 107, display 108, and memory 109. The processing system 102 includes the CPU (Central Processing Unit) and other processing units that are responsible for executing various applications 103 and performing various computational tasks, including decoding multimedia content, managing streaming protocols, handling user interface interactions. The applications 103 are software programs stored in memory 109 and responsible for performing specific functions or provide certain features. In some embodiments, the applications 103 include a media player application 104 (hereinafter “player”) responsible for handling the playback of multimedia content such as main content of a content item or Ad content of a PauseAd. The player 104 may be integrated with the UI 105 and present controls and visual feedback on the display 108 for user interaction.

The player 104 may be a product of a player software development kit (SDK), which includes a set of software tools, libraries, and documentation. In some embodiments, the player 104 may be specifically designed to integrate with the content provider system 110 to deliver a smooth streaming experience on the user device 101. For example, the player may include media playback engine responsible for decoding and rendering multimedia content, video and audio synchronization, buffering, and playback controls, application programing interface (API) responsible for starting, pausing, stopping playback, seeking, and retrieving playback status, integration documentation responsible for providing guidelines for integrating the player 104 into different platforms or applications, and so on. The player SDK is configured with the capability to play both traditional multimedia content and PauseAds.

The player 104 may initiate a player instance once triggered by a user interaction event (e.g., when user clicks a “play” button on the UI 105). A “player instance” used herein refers to a distinct occurrence or instantiation of a player within a given software application. A player instance represents an active, executable entity that is capable of managing and facilitating the playback of multimedia content. A player instance may be created and controlled through the utilization of a player SDK or a similar framework. A “single player instance” refers to a singular occurrence of a player within a given software application, and only one instance of the player is active and managing multimedia playback without interfering with other instances. Multiple player instances, on the other hand, involve having more than one occurrence of a player within a given software application or system, and each instance operates independently and can manage its own multimedia playback. In some embodiments, the content provider system 110 can support single player instance as well as multiple player instances. In some embodiments, the content provider system 110 can only support single player instance.

The UI 105 includes a graphical user interface (GUI) displayed on the display 108 and featuring playback controls (play, pause, rewind, etc.), navigation menus, a visually engaging display area, and various interactive elements for user interaction. In some embodiments, the UI 105 may integrate with various multimedia formats, supporting audio, video, and images, and offers playlist management for personalized content experiences. The UI 105 may provide interactive features that respond dynamically to touch gestures, mouse clicks, or remote control inputs. The UI 105 may interact with network interface 106 for online content streaming and may be configured to be responsive across different screen sizes.

Network interface 106 is configured to facilitate communication between the user device 101 and communications network 160, which can include the Internet and, possibly, various other public and/or private networks through which communication with user device 101 can be performed. The multimedia content can be streamed and received by user device 101. In some embodiments, the display 108 is an independent display device connected to the user device 101, for example, via output interface 107. The content output by the user device 101 may be presented by the display 108. In some embodiments, a remote control (not shown) may allow a user to provide input to user device 101 wirelessly through the UI 105.

Communications network 160 communicatively interconnects the various components of communications system 100. The communications network 160 may utilize any known and/or later arising communications and/or networking technologies, standards, protocols or otherwise. Non-limiting examples of such technologies include packet switch and circuit switched communications technologies, such as and without limitation, Wide Area Networks (WAN), such as the Internet, Local Area Networks (LAN), cellular communications networks such as a 3G/4G/5G/6G or other cellular network, Internet of Things (IoT) networks, cloud based networks, private networks, public networks, or otherwise. In some embodiments, communications network 160 further includes a Content Delivery Network (CDN) to enhance content delivery. The CDN may an integral part of the network infrastructure of the communications system 100 and includes content servers, edge servers, routers, load balancers, etc., for optimizing the distribution of multimedia content to user device 101. The content servers may be included in the content provider system 110 for storing and hosting multimedia content, edge servers are positioned closer to the user device 101 to cache and deliver content, routers manage the flow of data, and load balancers distribute traffic across servers to optimize content distribution and delivery as well as resource utilization.

Content provider system 110 includes, among other components, communications device 111, authentication device 112, content manifest generator 113, event tracking device 114, content analytical device 115, thumbnail image generator 116, Ad template generator 117, Ad template classification device 118, Ad template identification device 119, and database 120. “Device” used herein refers to a physical hardware component, a software component, or a combination of both, such as a server, an engine, a module, or any tangible or intangible entity or a combination of both that can serve a particular purpose or perform a particular function.

The communications device 111 is generally responsible for facilitating data exchange within the content provider system 110 as well as between the content provider system 110 and another component within the communications system 100. The communications device 111 may include networking capabilities for sending and receiving messages, signals, content, files and associated metadata, manifest files, manifest Uniform Resource Locator (URL), and various other types of data and information. For example, the communication device 111 may facilitate transmitting and receiving messages between the content provider system 110 and the user device 101.

The authentication device 112 is generally responsible for verifying and validating user access to multimedia content or content items to allow the authorized users to interact with or retrieve specific content. As used herein, “content” refers to any humanly perceptible information, such as video, television programs, audio programs, speeches, concerts, gaming, or otherwise. The content may originate from any source, including live, augmented reality, virtual reality, computer generated, or otherwise. The content may be presented to a given user using any desired user device such as the user device 101. The content may be presented to one or more users “real-time” (which is defined herein to mean as the underlying action provided in such content first occurs in time), on a recorded, time delayed, time shifted, or any other basis. “Main content” refers to the primary audio or video stream that users intend to watch or listen to. “Ad content” or “PauseAd content” refers to the advertisements that are displayed when a viewer pauses the main content.

The content manifest generator 113 is responsible for generating manifest data that describes the structure, properties, and location of content items. In some embodiments, the content manifest generator 113 may include, among other components, a metadata ingestion module, a manifest template module, a URL generation and formatting module, a quality of service (QOS) configuration module, a segmentation module, a content protection module, and a manifest versioning module.

The metadata ingestion module is generally responsible for collecting and ingesting metadata associated with content items. Metadata may include information such as title, duration, format, and other relevant details. The manifest template module is responsible for generating manifest templates that outline the structure and composition of the content manifest. The templates may include placeholders for adapting to different content types.

The URL generation and formatting module is generally responsible for generating and structuring URLs that point to specific locations where content-related resources, such as manifest files and content segments and can be retrieved. The URL generation and formatting module can determine the correct location or address from which the player should fetch content-related resources, constructs the URL in accordance with the specified protocols, such as HTTP or HTTPS, incorporate dynamic parameters into the URL as needed, dynamically structure URLs to support different bitrates or resolutions based on the configuration of the play instance and/or network conditions.

The QoS configuration module is generally responsible for configuring parameters that influence the quality of the multimedia content delivery. The segmentation module is generally responsible for dividing the multimedia content of a content item into segments, each representing a portion of the content's duration.

The content protection module is generally responsible for integrating security measures and mechanisms to safeguard the multimedia content from unauthorized access and distribution. In some embodiments, the content protection module integrates with digital rights management (DMR) systems to apply encryption to the multimedia content, and only authenticated or authorized users with the appropriate keys or licenses can decrypt and access the content. In some embodiments, the content protection module is configured to manage the generation, distribution, and revocation of encryption keys and implements secure mechanisms for exchanging encryption keys between the content provider system 110 and the user device 101.

The manifest versioning module is generally responsible for managing and tracking versions of the manifest files. The manifest versioning module may be configured to assign a version number to each iteration of the manifest file, monitor and track changes made to the manifest file (e.g. modifications to content structure, metadata, URLs, or any other relevant information) over time, coordinate with the CDN to distribute and cache the correct version of the manifest cached across the network, and facilitate the dynamic updating of manifest files with real-time adjustments and improvements without requiring a complete redistribution of the entire content.

As mentioned above, the manifest data generated by the content manifest generator 113 may include a content manifest file 121 and a content manifest URL 122. The content manifest file 121 includes data (e.g., asset metadata) or information indicating the content's title, description, duration, available bitrates for adaptive streaming, resolution, encoding format, segmentation information, accessibility features, content protection mechanisms, thumbnail references, and version information. The content manifest file 121 acts as an instruction for the player 104 of the user device 101 and provides a roadmap for content retrieval, decoding, and presentation. The content manifest URL 122 serves as the address or link pointing to the location from which the manifest file 121 can be fetched. The content manifest file 121 and content manifest URL 122 may be stored in the database 120 and can be retrieved or fetched by the user device 101.

The event tracking device 114 is responsible for tracking a player instance initiated and maintained by the player 104 on the user device 101. In some embodiments, the event tracking device 114 can capture and record various events and interactions associated with the player instance. The event tracking device 114 can monitor events such as the start and end of playback, user interactions (e.g., pausing, seeking, and resuming), buffering events, error occurrences, and other relevant actions performed within the player instance. The event tracking device 114 can obtain precise and accurate timestamps indicating the exact time when specific events occur within the player instance, such as pausing and resuming and record the temporal aspects of user interactions with the multimedia content.

The content analytical device 115 is generally responsible for analyzing the content of a content item. In some embodiments, the content analytical device 115 can precisely identify and extract a visual representation of the content at the specified moment in time. For example, the content analytical device 115 can navigate through the content item based on timestamps, identify specific events within the player instance, such as pausing, resuming, or any other user interactions that may be timestamped, accurately pinpoint the specific timestamp of interest corresponding to a particular moment of an event within the player instance, locate and capture the visual representation of the content at the pinpointed timestamp. In some embodiments, the content analytical device 115 may generate thumbnail images from the extracted images for storage, retrieval, or presentation purposes.

The thumbnail image generator 116 is generally responsible for generating a thumbnail image. In some embodiments, the thumbnail image generator 116 is integrated to the content analytical device 115. In other embodiments, the thumbnail image generator 116 may be an independent component. A “thumbnail image” used herein refers to a visual preview or summary that provides a glimpse of the content to allow users to quickly identify and comprehend the nature of the content. In some embodiments, the thumbnail image may be a smaller, reduced-size representation of a larger image of the content. The thumbnail image generator 116 may receive relevant data from the content analytical device 115, such as identified key moments, specific timestamps, or visual characteristics of the content. In some embodiments, the thumbnail image generator 116 is configured to detect the occurrence of a pause event within the player instance, capture the precise timestamp associated with the moment when the content flow is paused, request or retrieve relevant content data, such as images or visual frames, specifically at the timestamp when the pause event occurred, generate a thumbnail image that reflects the visual content at the paused moment, and send the generated thumbnail image to the database 120 for temporary storage.

The Ad template generator 117 is responsible for creating templates that define the structure and layout of advertisements (Ads) to be displayed during content playback. The Ad templates serve as frameworks for organizing Ad content and can be stored in database 120. An example Ad template may include various configuration parameters such as a placeholder for the duration or time length of the ad, a generic field for specifying media elements, such as images, videos, or audio clips, placeholder fields for various text elements, generic fields for branding elements and logos, placeholder fields for interactive elements, such as clickable areas or buttons, default display frequency, default dimensions and formats for the ad, among others.

The Ad template classification device 118 is responsible for categorizing or classifying Ad templates 123 based on various attributes, characteristics, or predefined criteria. In some embodiments, the Ad templates 123 can be classified based on the characteristics of the content item, for example, the theme or genre of the associated content item, the visual style of the content item, the tone and mood of the content item, the duration of the associated content item, the contextual relevance to the content item, the demographics of the audience engaging with the associated content, among others.

The Ad template identification device 119 is responsible for identifying an Ad template to be used for playing PauseAd within an ongoing player instance. In some embodiments, the Ad template identification device 119 may obtain the characteristics, theme, or relevant attributes of the main content within the ongoing player instance and utilize the classification information associated with Ad templates to identify an Ad template that align with the characteristics of the ongoing content and/or the desired advertising goals.

It should be noted that the Ad templates are generated by the content provider system 110 and can be provided to the user device 101 upon initiation of a player instance (e.g., before a playback event such as pausing occurs within the player instance). The Ad template can be identified and determined by the content provider system 110. The proactive delivery of Ad templates allows the user device to be preconfigured with structured frameworks and optimize the integration of Ad into the content playback experience.

The dynamic manifest provider system (DMPS) 130 is generally responsible for dynamically generating Ad manifest data and providing the Ad manifest data to the user device 101. In some embodiments, DMPS 130 further includes a communications module 131, an Ad manifest generator 132, and a database 133. The communications module 131 is responsible for facilitating communication (e.g., signal transmission and reception, message exchange, file transfer, etc.) between DMPS 130 and various other components of the communications system 100. In some embodiments, the communications module 131 enables DMPS 130 to receive an Ad manifest request (e.g., a request for an Ad manifest) sent from the content provider system 110 and sent an Ad manifest response (e.g., a response including Ad manifest data such as Ad manifest file or Ad manifest URL) to the content provider system 110. In some embodiments, the communications module 131 enables DMPS 130 to send an Ad request to the Ad provider 140 and receive an Ad response from the Ad provider 140.

Ad manifest generator 132 is responsible for generating Ad manifest file data and caching the generated Ad manifest file. In some embodiments, the Ad manifest generator 132 and the content manifest generator 113 are integrated to form a single manifest generator that is operable to generate and manage both content manifest file and the Ad manifest file. Ad manifest data may include an Ad manifest file 134 and an Ad manifest URL associated with the Ad manifest file. Ad manifest generator 132 can interface with the Ad provider 140 to obtain PauseAd information, analyze the PauseAd information, and dynamically generates the Ad manifest file 134 in a timely manner, aligning with the specifics of the PauseAd information. The dynamic nature of the Ad manifest generator 132 underscores its flexibility and adaptability to enable the real-time generation of Ad manifest data tailored to the PauseAd information provided by the Ad provider 140. This dynamic capability can allow the advertising content to be integrated with the content playback experience within a specific player instance and enhance the agility and responsiveness of the Ad delivery process.

The database 133 within the DMPS 130 is configured to store Ad manifest data such as Ad manifest file and Ad manifest URL in the database. For example, DMPS 130 may receive an Ad response from the Ad provider 140, the Ad response may include an Ad manifest file and a manifest URL corresponding to the Ad manifest file. The Ad manifest file and Ad manifest URL may be temporarily stored in the database 133 for the content provider system 110 or the user device 101 to fetch.

Ad manifest file 134 may include metadata and other data associated with playing PauseAd within a specific player instance. The metadata within the Ad manifest file 134 may further include data entry or information such as Ad duration, specifications, playback instruction, targeting parameters, and any other pertinent data necessary for the player instance to render and display the PauseAd accurately. By incorporation of a range of contextual information, the Ad manifest file 134 allows the PauseAd to be delivered and presented in accordance with the specific requirements and characteristics of the designated player instance and contribute to a cohesive and tailored ad playback experience. The Ad manifest URL corresponding to or associated with the Ad manifest file 134 may also be generated and sent to user device 101 to allow the user device 101 to fetch the Ad manifest file 134 by following the corresponding to Ad manifest file 134.

The Ad provider 140 may include a server or computing system that further includes a communications module 141, an Ad determination module 142, and an Ad URL generator 143. The communications module 141 is responsible for facilitating communication (e.g., signal transmission and reception, message exchange, file transfer, etc.) between the Ad provider 140 and various other components of the communications system 100. In some embodiments, the communications module 141 enables the Ad provider to receive an Ad request from the DMPS 130 and send an Ad response containing PauseAd information to the DMPS 130. In some embodiments, the Ad request may include various information such as player instance information (e.g., identifier and streaming session information), content information, user information, and so on. The communications module 141 may also enable the Ad provider 140 to communicate with Ad server 150 to locate the Ad item or Ad segment for the PauseAd. In some embodiments, the communications module 141 enables the Ad provider 140 to send an Ad segment request to the Ad server 150 and receive an Ad segment response containing the Ad segment information from the Ad server 150.

The Ad determination module 142 is configured to determine an Ad item (e.g., an Ad clip, an Ad segment, a list of Ad clips or Ad segment, etc.) to be played within the player instance on the user device 101. In some embodiments, the Ad determination module 142 may analyze the Ad request to extract the various information included in the Ad request and determine the Ad segment based on the information. The Ad URL generator 143 is responsible for generating an URL corresponding to the Ad segment or Ad item determined by the Ad provider 140, based on the location of the Ad segment and Ad item within the Ad server 150. The Ad URL may be included in the Ad response to be sent to the DMPS 130 in response to an Ad request.

Ad server 150 may include a server or computing system that further includes a communications module 151 and an Ad database 152. The communications module 151 is responsible for facilitating communication (e.g., signal transmission and reception, message exchange, file transfer, etc.) between the Ad server 150 and various other components of the communications system 100. The Ad database 152 is configured to store the Ad segment or Ad item for PauseAd to be played in a player instance. The Ad segment or Ad item may be fetched or retrieved by the user device 101 or other components within the communications system 100. In some embodiments, Ad server 150 may provide location information of a particular Ad segment or Ad item to the Ad provider 140, and Ad provider 140 may generate an Ad URL corresponding to the Ad segment or Ad item, based on the location information.

It should be noted that variations of the communications system 100 are also within the scope of the present disclosure. In some embodiments, the DMPS 130 may be integrated to the content provider system 110. In some embodiments, the content manifest generator 113 is integrated to the DMPS 130, such that the DMPS can generate the content manifest files as well as the Ad manifest files. In some embodiments, the event tracking device 114 and the content analytical device 115 may be integrated to the thumbnail image generator. In some embodiments, the Ad server 150 is integrated to the Ad provider 140.

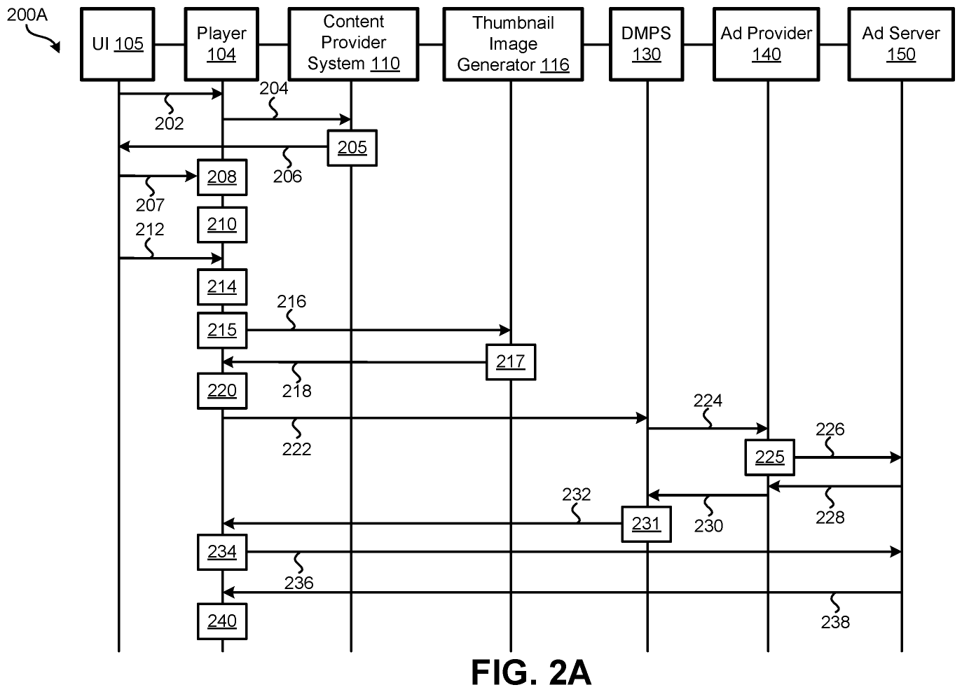

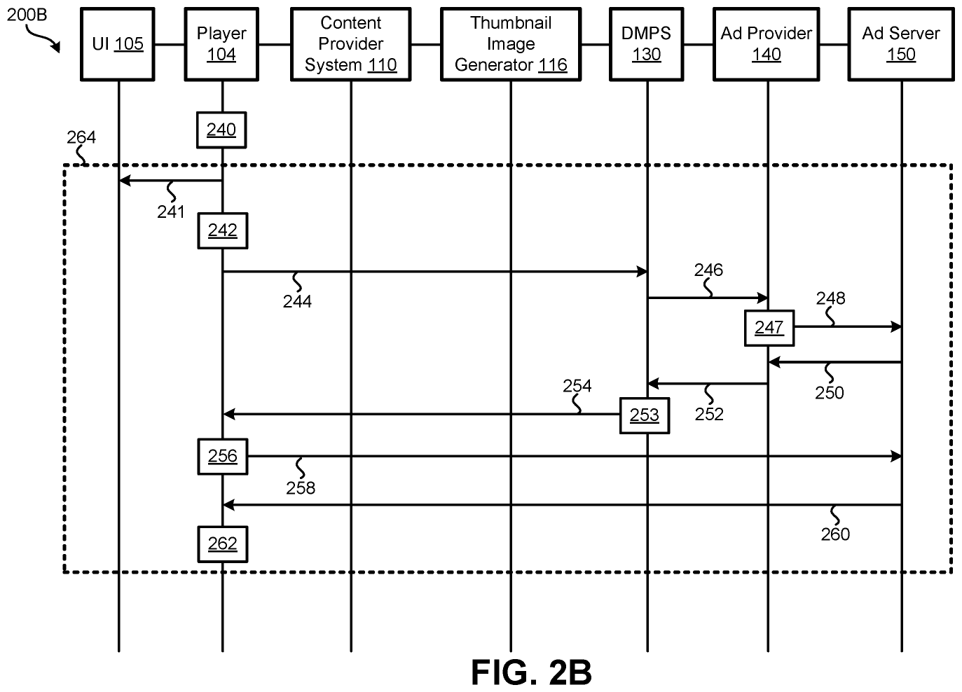

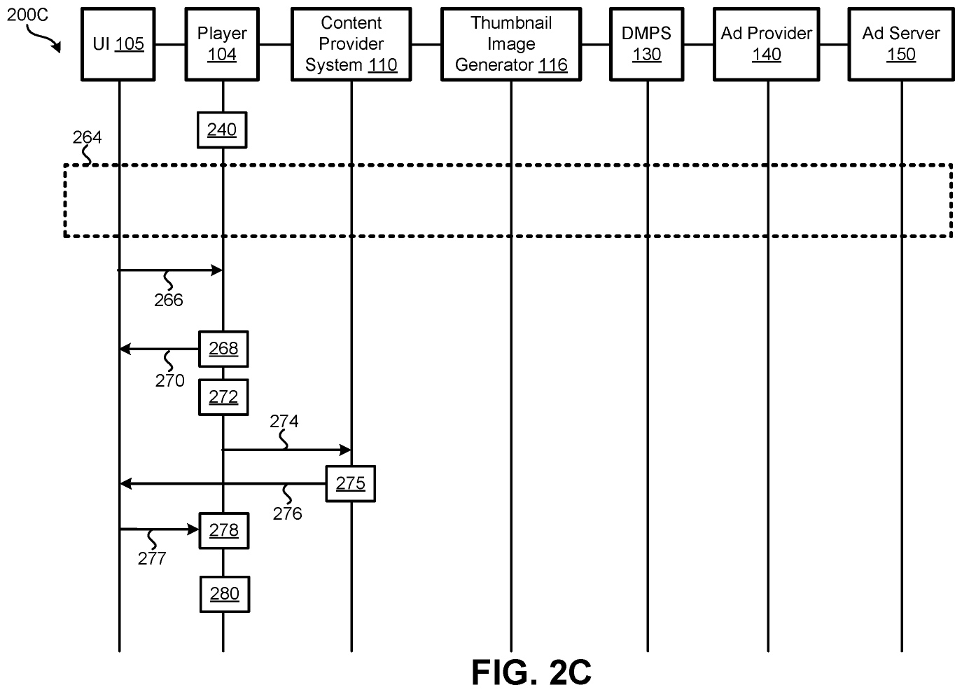

FIGS. 2A-2C are message flow diagrams respectively illustrating example processes for delivering PauseAd and/or providing PauseAd services, according to various embodiments of the present disclosure. FIG. 2A illustrates an example of flow process 200A. Process 200A may commence when a user operating a user device 101 activates a player 104 on the user device 101 to consume multimedia content of a content item. For example, UI 105 may send a user request (TRANSMISSION 202) to the player 104 for playing main content of a content item. Upon receiving the user request, player 104 may send a request (TRANSMISSION 204) for the main content of the content item to the content provider system 110. The request may contain user information such as user identity, user authentication information, and account information, content item information, etc.

Upon receiving the user information, the content provider system 110 may perform authentication (FUNCTION 205) to authorize the user based on the user information, generate a content manifest file for the requested content and a content manifest URL associated with the content manifest file, and identify and determine one or more Ad templates for PauseAd to be played on the player 104. The content provider system 110 subsequently delivers (TRANSMISSION 206) the information associated with the content item, the content manifest file and the associated content manifest URL, as well as the Ad template and the Ad template URL associated with the Ad template to the player 104 and the UI 105. The content manifest file may include asset metadata associated with the requested content. The information associated with the content may further include a content URL associated with the request content for the player 104 to follow and fetch the request content. The Ad template may be identified and determined by the content provider system 110 based on the information associated with the content (e.g., genre, duration, and other characteristics of the content) and/or the user information (e.g., user identity, user characteristics, user membership level, user experience, user account type, etc.).

Upon receiving the content manifest file and asset metadata included therein, the UI 105 may transmit a user command (TRANSMISSION 207) to the player 104 to initiate a player instance. Upon receiving the user command, the player 104 may initiate (FUNCTION 208) a player instance for playback of the content, according to the content manifest file. In some embodiments, the player 104 may follow the content URL to fetch the main content of the content item from the content provider system 110. The player 104 may initiate a streaming session (FUNCTION 210) for playback of the main content within the player instance. In the streaming session, the player 104 may perform various functions such as retrieving, buffering, and rendering the content for the user to consume, in response to user input from UI 105. In some embodiments, the UI 105 may automatically enable/activate PauseAd function during the streaming session for delivery of both main content and PauseAd within the same player instance.

The Ad template may be transmitted to and received by the user device 101 before initiation of a player instance or a content streaming session (also referred to as a “main content streaming session”). In some embodiments, the Ad template is received before occurrence of any user interaction event after initiation of the content streaming session. The UI 105 send a user request (e.g., a user interaction event) for pausing the content streaming session (TRANSMISSION 212) at a time after the Ad template is received by the user device. Upon receiving the user request, the player 104 executes a pause operation (FUNCTION 214) to temporarily halt the content streaming session within the single player instance at a time point (i.e., paused moment). In some embodiments, the player 104, in response to the pause command, automatically presents an image representing the paused content (also referred to as a paused image). This visual representation serves as a snapshot or placeholder to provide user a visual reference of the paused moment in the content playback of the content streaming session. The automatic display of a paused image enhances the user experience during pauses and provide a visual context and maintaining engagement while accommodating the user interaction in content playback.

In some embodiments, the content streaming session involves DRM-protected content, and capturing images directly from the player 104 can be restricted due to the security measures implemented by DRM. This limitation poses a challenge when attempting to present the image of the paused content for visual representation during pauses in the content streaming session. In this scenario, upon receiving the user command to pause the content streaming session, the player 104 promptly initiates a request (FUNCTION 215) and sends the request (TRANSMISSION 216) to the thumbnail image generator 116. The request is specifically for obtaining a thumbnail image representing the paused content. Given the DRM protection, the thumbnail image generator 116 serves as a specialized service capable of securely generating precise thumbnail images based on timestamps.

In some embodiments, the player 104 employs a timing strategy when initiating a request for thumbnail image to the thumbnail image generator 116. The player 104 may wait for the elapse of a first predetermined period of time after the pause of the content streaming session and before generating and sending the request. The first predetermined period is designed to allow for any initial buffering or stabilization processes to settle after the pause command to provide a more stable and representative state of the paused content. In some embodiments, the first predetermined period of time is of 1 second to 10 seconds. In some embodiments, the first predetermined period of time is 5 seconds. The introduction of the delay before requesting the thumbnail image can allow for capturing a moment that reflects the paused content and minimizing transient states that might occur immediately after pausing.

In some embodiments, the event tracking device 114 and content analytical device 115 may coordinate with the thumbnail image generator 116 to perform the following operations (FUNCTION 217): precisely tracking the time of pausing during the content streaming session, aligning the time of pausing (e.g., the first time point or the paused moment) with the timestamp of the content derived from the content manifest, determining the exact timestamp at the paused moment, and subsequently locating the corresponding thumbnail image based on this determined timestamp. The thumbnail image generator 116 subsequently sends the thumbnail image (TRANSMISSION 218) to the player 104. Upon reception of the thumbnail image from the thumbnail image generator 116, the player 104 proceeds to display (FUNCTION 220) the thumbnail image within the player instance and presented to the user. The presentation of the thumbnail image serves as an interim visual representation during the pause period and provide users a static image capturing the precise moment when the content streaming session was paused.

In some embodiments, the player 104 follows a timed sequence of operations related to the pause of the content streaming session. After the elapse of a second predetermined period of time, either immediately following the pause or after the completion of the first predetermined period, the player 104 sends (TRANSMISSION 222) an Ad manifest request (e.g., a first Ad manifest request) for a first PauseAd to the DMPS 130. The sequence is designed to introduce a delay before requesting the Ad manifest, allowing for stability in the paused state and potentially avoiding transient conditions that might occur immediately after pausing. The second predetermined period may serve as a buffer to allow the content streaming session to settled into a stable state before the player 104 requests the Ad manifest. The timing sequence is implemented to enhance the synchronization between the display of the thumbnail image and the retrieval of the Ad manifest and contribute to a smoother transition and improved user experience during the pause in the content streaming session.

Upon receiving the Ad manifest request, DMPS 130 sends (TRANSMISSION 224) an Ad request (e.g., a first Ad request) to Ad provider 140. In some embodiments, the Ad request may include various information such as player instance information (e.g., identifier and content streaming session information), content information, user information, and so on. Upon receiving the Ad request, the Ad provider 140 may determine (FUNCTION 225) an Ad segment (e.g., a first Ad segment) to be played as a PauseAd (e.g., a first PauseAd) for the player instance, based on the information included in the Ad request. In some embodiments, the Ad provider 140 may analyze the relevance of available Ad item or Ad segments to the paused content streaming session, taking into factors such as Ad format, duration, and alignment with user experience and preference. The Ad provider 140 subsequently sends (TRANSMISSION 226) an Ad content request (e.g., a first Ad content request) to Ad server 150 to locate the Ad item or Ad segment in the Ad database 153 of the Ad server 150. The Ad content request may include a unique identity or registration information of the Ad item or Ad segment determined by the Ad provider 140 as well as other information such as player instance information, content information, and user information.

Upon receiving the Ad content request, the Ad server 150 locates the Ad item or Ad segment based on the information included in the Ad content request and sends (TRANSMISSION 228) an Ad content response (e.g., a first Ad content response) to the Ad provider 140. The Ad content response contains location information of the Ad item or Ad segment stored in the database. In some embodiments, the Ad server 150 generates an Ad URL (e.g., a first Ad URL) corresponding to the Ad item or Ad segment and includes the Ad URL in the Ad content response. Upon receiving the Ad content response from the Ad server 150, the Ad provider 140 generates an Ad response (e.g., a first Ad response) that includes the Ad URL corresponding to the Ad item or Ad segment and sends (TRANSMISSION 230) to the DMPS 130. Upon receiving of the Ad response from the Ad provider 140, the DMPS 130 generates (FUNCTION 231) an Ad manifest response (e.g., a first Ad manifest response) and sends (TRANSMISSION 232) to the player 104. The Ad manifest response may include an Ad manifest file (e.g., a first Ad manifest file), an Ad manifest URL (e.g., a first Ad manifest URL) corresponding to the Ad manifest file, and the Ad URL (e.g., the first Ad URL) corresponding to the Ad item or Ad segment.

Upon receiving the Ad manifest response, the player 104 may automatically initiate (FUNCTION 234) an PauseAd streaming session (e.g., a first Pause Ad session or a first PauseAd streaming session) to play the PauseAd within the player instance. The player 104 may send (TRANSMISSION 236) a request for fetching/retrieving the Ad item or Ad segment from the Ad server 150 using the Ad URL included in the Ad manifest response. Upon receiving the request, the Ad server 150 may transmit (TRANSMISSION 238) the Ad item or Ad segment to the player 104 or otherwise allow the player 104 to download and access the Ad item or Ad segment. The player 104 may initiate (FUNCTION 240) playback of Ad item or Ad segment in the PauseAd session, according to the Ad manifest file.

FIG. 2B illustrates an example of flow process 200B. Process 200B provides an example of successively and sequentially playing multiple PauseAds in the same PauseAd streaming session and within the same player instance. Process 200B may follow Process 200A. In the illustrated example, process 200B commences when player 104 initiates (FUNCTION 240) the playback of a first Ad segment in the PauseAd session (e.g., in process 200A). Concurrently with or immediately after the playback of a first Ad segment is initiated, player 104 sends (TRANSMISSION 241) a notification to UI 105 that the playback of first PauseAd is initiated. Player 104 may determine (FUNCTION 242) that a predetermined period of time elapses before the playback of the first Ad segment is completed and that no user interaction event (e.g., receiving a user request from UI 105 to resume the playback of the main content) occurs during the predetermined period of time. In some embodiments, the predetermined period of time is 1 second to 10 seconds.

Operations 244-262 of process 200B are similar to operations 222-240 of process 200A. Player 104 sends a second Ad manifest request (TRANSMISSION 244) for a second PauseAd to the DMPS 130, similar to TRANSMISSION 222 of process 200A. Upon receiving the second Ad manifest request, DMPS 130 sends (TRANSMISSION 246) a second Ad request to Ad provider 140, similar to TRANSMISSION 224 of process 200A. Upon receiving the second Ad request, the Ad provider 140 may determine (FUNCTION 247) a second Ad segment to be played as a second PauseAd for the player instance, similar to FUNCTION 225 of process 200A. The Ad provider 140 subsequently sends (TRANSMISSION 248) a second Ad content request to Ad server 150 to locate the second Ad segment in the Ad database 153 of the Ad server 150, similar to TRANSMISSION 226 of process 200A. Upon receiving the second Ad content request, the Ad server 150 locates the second Ad segment based on the information included in the second Ad content request and sends (TRANSMISSION 250) a second Ad content response to the Ad provider 140, similar to TRANSMISSION 228 of process 200A. In some embodiments, the Ad server 150 generates a second Ad URL corresponding to the second Ad segment and includes the second Ad URL in the second Ad content response.

Upon receiving the second Ad content response from the Ad server 150, the Ad provider 140 generates a second Ad response that includes the Ad URL corresponding to the Ad item or Ad segment and sends (TRANSMISSION 252) to the DMPS 130. Upon receiving of the second Ad response from the Ad provider 140, the DMPS 130 generates (FUNCTION 253) a second Ad manifest response and sends (TRANSMISSION 254) to the player 104. The second Ad manifest response may include a second Ad manifest file, a second Ad manifest URL corresponding to the Ad manifest file, and the second Ad URL corresponding to the Ad item or Ad segment.

Upon receiving the second Ad manifest response, the player 104 may automatically initiate (FUNCTION 256) a second PauseAd streaming session to play the second PauseAd within the same player instance, after the playback of the first PauseAd (e.g., the first PauseAd session) is completed. The player 104 may send (TRANSMISSION 258) a request for fetching/retrieving the second Ad segment from the Ad server 150 using the second Ad URL included in the second Ad manifest response. Upon receiving the request, the Ad server 150 may transmit (TRANSMISSION 260) the second Ad segment to the player 104 or otherwise allow the player 104 to download and access the second Ad segment. The player 104 may initiate (FUNCTION 262) playback of the second Ad segment in the second PauseAd session, according to the second Ad manifest file.

In some embodiments, player 104 is configured to proactively and periodically sends multiple Ad manifest requests at a specified frequency or time interval (TRANSMISSION 244) to DMPS 130. For example, the frequency may be one Ad manifest request per two seconds. The multiple Ad manifest requests may include a first manifest request and a second manifest request. The first Ad manifest request automatically triggers the population and playback of the first PauseAd. Subsequently, the second Ad manifest request, sent at a later time, serves as an anticipatory action by the player 104 to automatically trigger the population of the second PauseAd. The second PauseAd can be automatically populated when the player 104 sends the second Ad manifest request to DMPS 130 and triggered when the playing of the first PauseAd is near its end in the PauseAd session. Such configuration may facilitate a seamless transition between PauseAds to allow the player 104 to prepare for the next Ad segment before the first one concludes, thereby enhancing the continuity of the PauseAd playback experience.

Operations 241-262 of process 2B may be repeated in a loop (LOOP 264) within the same play instance to allow for the continuous playback of multiple PauseAds during the time when the main content remains paused and in the absence of user interaction events to resume the playback of the main content. This dynamic and cyclic design improves the user engaging experience with successive PauseAds in a single player instance.

FIG. 2C illustrates an example of flow process 200C. Process 200C provides an example of transition from the playback of PauseAd to the playback of the main content within the same play instance. Process 200C may follow process 200A or process 200B. In the illustrated example, during the playback of the first Ad segment (e.g., FUNCTION 240) in the first PauseAd session or the subsequent PauseAds (e.g., FUNCTION 262 in LOOP 264), if the user intends to halt the PauseAd playback, the UI 105 sends (TRANSMISSION 266) a user request for a user interaction event to the player 104. The user interaction event may involve resuming the playback of the main content (e.g., resuming the content streaming session) or taking action to stop the playback of the PauseAd altogether.

Immediately after receiving the user request, player 104 terminates playback (FUNCTION 268) of the PauseAd and sends (TRANSMISSION 270) a notification to UI 105 that the PauseAd session is terminated. Simultaneously or substantially simultaneously, player 104 presents (FUNCTION 272) the thumbnail image of the paused content (i.e., the main content at the paused moment of the content streaming session) on the display. Since the thumbnail image has been previously downloaded and stored in the memory of the user device 101, the player 104 can quickly retrieve the thumbnail image from the memory and display it on the screen. This instantaneous presentation of the thumbnail image serves as an alternative to a black screen or buffering indicator to enhance the user experience during the transition from PauseAd playback to the display of the main content.

During the presentation of the thumbnail image, the player 104 initiates a content manifest update request and sends the content manifest update request (TRANSMISSION 274) to the content provider system 110, signaling the intent to resume playback of the main content from the paused moment within the same player instance. Upon receiving the content manifest update request, the content provider system 110 responds by generating (TRANSMISSION 275) an updated content manifest file and an associated updated content manifest URL.

The updated content manifest file may include information such as updated asset metadata related to the main content, the timestamp corresponding to the paused moment depicted in the thumbnail image, and instructions for resuming playback based on this timestamp. Subsequently, the content provider system 110 delivers (TRANSMISSION 276) the updated content manifest file and its associated URL to both the player 104 and the UI 105.

Upon receiving the updated content manifest file, the UI 105 transmits (TRANSMISSION 277) a user command to the player 104, instructing the player 104 to resume the playback of the main content within the same player instance. In response, the player 104 executes the resume function (FUNCTION 278), according to the instruction provided in the updated content manifest file. The seamless transition allows the main content to resume playback from the paused moment and enhances the overall continuity of the user experience within the same player instance.

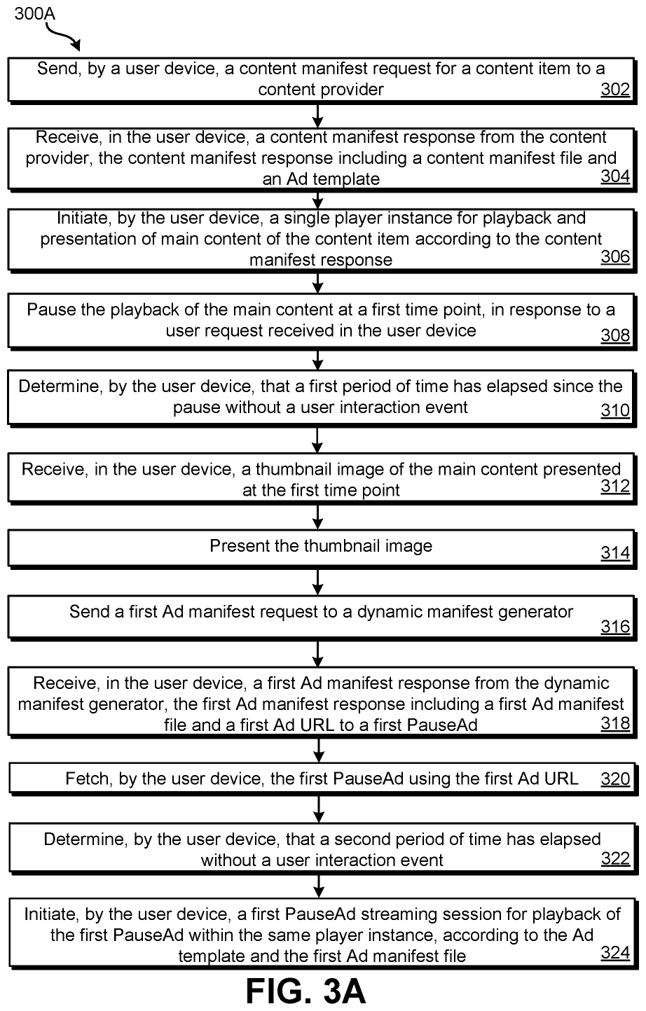

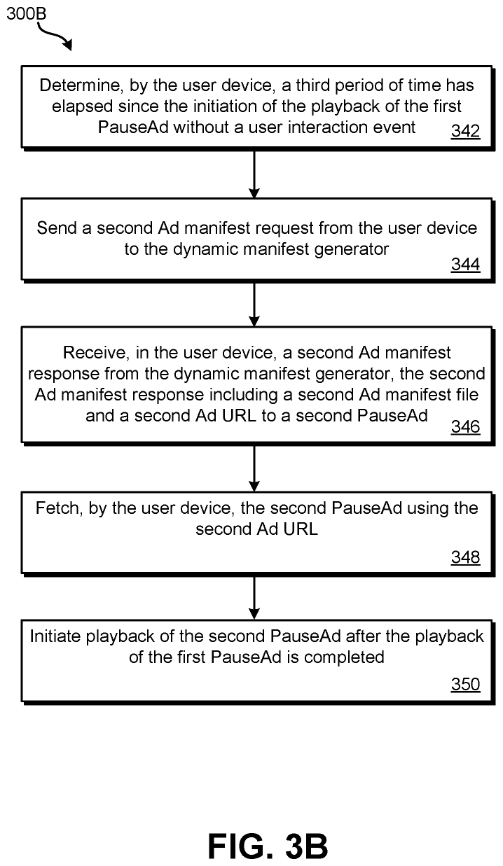

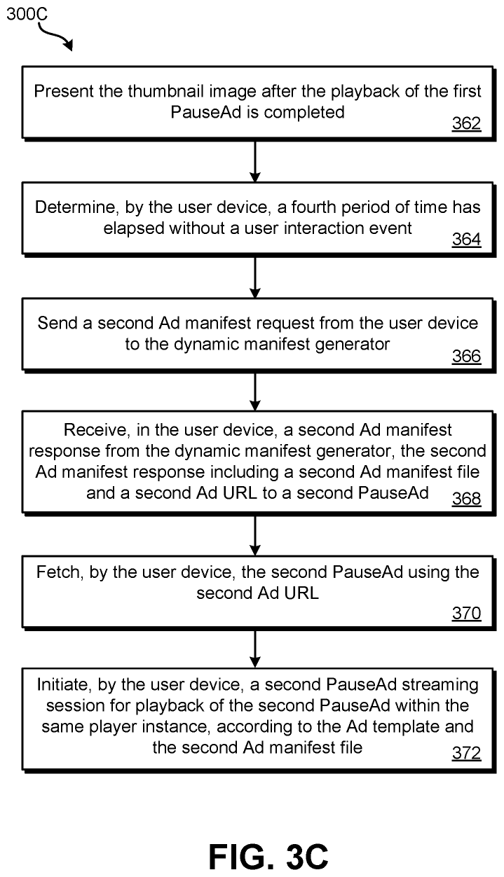

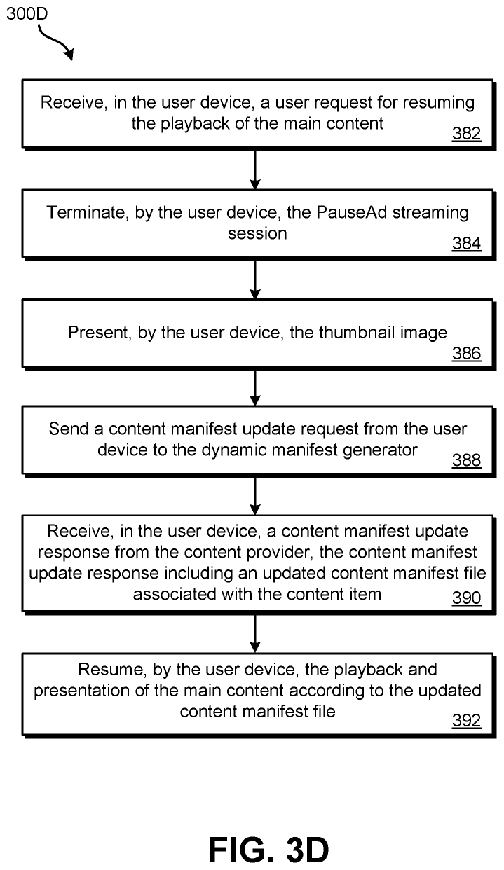

FIGS. 3A-3D are flow diagrams respectively illustrating example methods 300A-300D for providing PauseAd service. Methods 300A-300D may be performed by the communications system 100 or any component thereof. FIG. 3A illustrates method 300A. In the illustrated example, method 300A may include operations/steps 302-324. Few or additional operations/steps may be included. The operations of method 300A may be combined with operations of another method described herein in any suitable manner.

At 302, a content manifest request for playing a content item on a user device is sent from the user device to a content provider system. At 304, a content manifest response is received in the user device. The content manifest response is generated by the content provider system and includes a content manifest file and an Ad template. The content manifest file includes a content URL corresponding to the content item. At 306, a single player instance is initiated by the user device. Main content of the content item is fetched by the user device according to the content URL, and a content streaming session is initiated by the user device within the single player instance for playback and presentation of main content of the content item.

At 308, a user interaction event is detected by the user device. For example, a user interacts with the UI of the user device and a user request for pausing the playback of the main content is received by the user device. In response to the user request, the content streaming session is paused at a first time point (i.e., the paused moment), and the playback of the main content within the streaming session is simultaneously paused. At 310, a determination is made by the user device that a first period of time has elapsed since the pause of the content streaming session. At 312, a thumbnail image of the main content presented at the first time point is received in the user device. In some embodiments, the user device sends a request to the thumbnail image generator for obtaining the thumbnail image representing the paused content. The thumbnail image is generated by the thumbnail image generator by precisely tracking the time of pausing during the content streaming session, aligning the time of pausing with the timestamp of the content derived from the content manifest, determining the exact timestamp at the paused moment, and subsequently locating the corresponding thumbnail image based on this determined timestamp. At 314, the thumbnail image is presented by the user device on the display.

At 316, a first Ad manifest request for a first PauseAd is generated by the user device and sent to a dynamic manifest generator (e.g., Ad manifest generator). At 318, a first Ad manifest response is received in the user device. The first Ad manifest response is generated by the dynamic manifest generator and includes a first Ad manifest file, a first Ad manifest URL corresponding to the Ad manifest file, and a first Ad URL corresponding to the first PauseAd. In some embodiments, the Ad URL adheres to VAST (Video Ad Serving Template) standard protocols.

In some embodiments, the first Ad URL is accompanied by a beacon URL, which is also sent to and received in the user device. The beacon URL may be used for tracking and reporting various events related to PauseAd playback. The beacon URL may be triggered or “fired” when a specific user interaction event with the PauseAd occurs during PauseAd playback. Such user interaction events may include impressions, clicks, quartile tracking, or other user interactions.

At 320, the first PauseAd is fetched by the user device using the first Ad URL. At 322, a determination is made that a second period of time has elapsed without a user interaction event to stop the PauseAd playback. At 324, a first PauseAd streaming session for playback of the first PauseAd is initiated by the user device within the same player instance, according to the Ad template and the first Ad manifest file. The Ad content of the PauseAd is presented on the display using the instructions specified in the Ad template.

FIG. 3B illustrates method 300B. In the illustrated example, method 300B may include operations/steps 342-350. Few or additional operations/steps may be included. The operations of method 300B may be combined with operations of another method described herein in any suitable manner.

At 342, a determination is made by the user device that a third period of time has elapsed since the initiation of the playback of the first PauseAd without a user interaction event to stop the playback of the first PauseAd. At 344, a second Ad manifest request is sent from the user device to the dynamic manifest generator and received in the dynamic manifest generator. At 346, a second Ad manifest response sent from the dynamic manifest generator is received in the user device. The second Ad manifest response includes a second Ad manifest file and a second Ad URL to a second PauseAd. At 348, the Ad content of the second PauseAd is fetched by the user device from the second Ad URL. At 350, playback of the second PauseAd is initiated after the playback of the first PauseAd is completed, when no user interaction event occurs. In some embodiments, Operations 342-350 may be repeated in one or more loops to request, receive, initiate, and play multiple PauseAds (e.g., a third PauseAd, a fourth PauseAd, etc.) within the same PauseAd session and the player instance.

FIG. 3C illustrates method 300C. Method 300C is a variation of FIG. 3B. In the illustrated example, method 300C may include operations/steps 362-372. Few or additional operations/steps may be included. The operations of method 300C may be combined with operations of another method described herein in any suitable manner.

At 362, the thumbnail image previously downloaded by and stored in the memory of the user device is retrieved and presented after the playback of the first PauseAd is completed. At 364, a determination is made by the user device that the presentation of the thumbnail image has endured for a fourth period of time (e.g., a fourth period of time has elapsed since the initiation of the presentation of the thumbnail image without a user interaction event to resume the playback of the main content). At 366, a second Ad manifest request is sent from the user device to the dynamic manifest generator and received in the dynamic manifest generator. At 368, a second Ad manifest response sent from the dynamic manifest generator is received in the user device. The second Ad manifest response includes a second Ad manifest file and a second Ad URL to a second Pause Ad. At 370, the Ad content of the second PauseAd is fetched by the user device from the second Ad URL. At 372, a second PauseAd streaming session for playback of the second PauseAd within the same player instance is initiate by the user device, according to the Ad template and the second Ad manifest file. Operations 362-372 may be repeated in one or more loops to request, receive, initiate, and play multiple PauseAds (e.g., a third PauseAd, a fourth PauseAd, etc.) in different PauseAd streaming sessions within the same player instance.

FIG. 3D illustrates method 300D. In the illustrated example, method 300D may include operations/steps 382-392. Few or additional operations/steps may be included. The operations of method 300D may be combined with operations of another method described herein in any suitable manner.

At 382, a user interaction event for resuming the playback of the main content is detected by the user device. In some embodiments, a user input or user request for resuming the playback of the main content is generated in the UI and received in the user device. At 384, the PauseAd streaming session is terminated by the user device. At 386, the thumbnail image previously downloaded by and stored in the memory of the user device is retrieved and presented by the user device on the display within the same player instance. At 388, a content manifest update request is sent from the user device to the dynamic manifest generator. At 390, a content manifest update response is generated by and sent from the content provider, and the content manifest update response is received by the user device. The content manifest update response includes an updated content manifest file associated with the content item. At 392, the playback and presentation of the main content is resumed, by the user device, according to the updated content manifest file. The main content resumes playback from the timestamp corresponding to the paused moment with a seamless transition from the thumbnail image to the resumed playback. This allows the user to continue experiencing the main content from the exact point where it was paused.

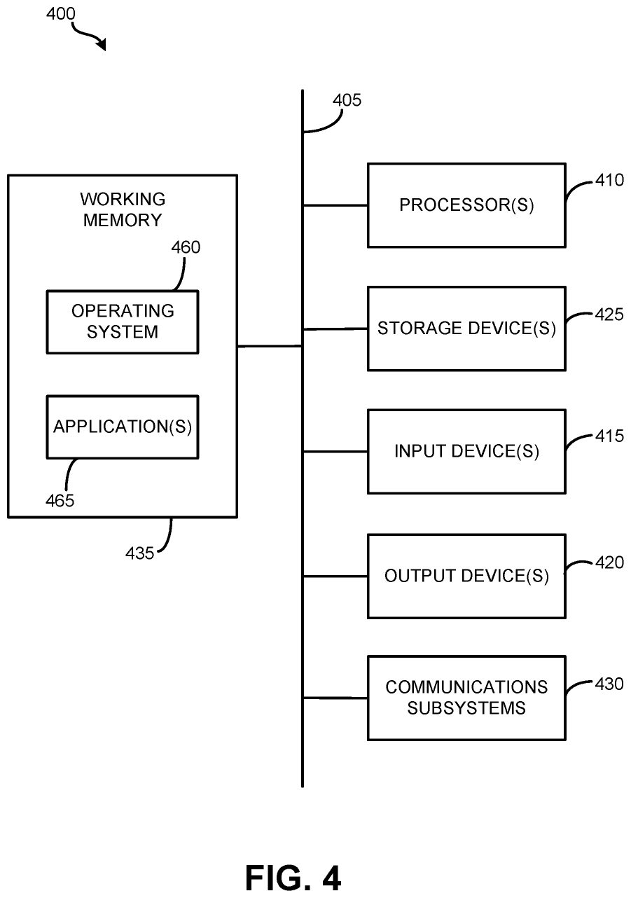

The communications systems 100 or any components thereof, such as the user device 101, content provider system 110, DMPS 130, Ad provider 140, Ad server 150 described above may include a computer system that further includes computer hardware and software that form special-purpose network circuitry to implement various embodiments such as communication, determination, identification, calculation, and other operations or steps of the methods or processes described herein. FIG. 4 is a schematic diagram illustrating an example of computer system 400. The computer system 400 is a simplified computer system that can be used to implement various embodiments described and illustrated herein. FIG. 4 provides a schematic illustration of one embodiment of a computer system 400 that can perform some or all of the steps of the methods and workflows provided by various embodiments. It should be noted that FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computer system 400 is shown including hardware elements that can be electrically coupled via a bus 405, or may otherwise be in communication, as appropriate. The hardware elements may include one or more processors 410, including without limitation one or more general-purpose processors and/or one or more special-purpose processors such as digital signal processing chips, graphics acceleration processors, and/or the like; one or more input devices 415, which can include without limitation a mouse, a keyboard, a camera, and/or the like; and one or more output devices 420, which can include without limitation a display device, a printer, and/or the like.

The computer system 400 may further include and/or be in communication with one or more non-transitory storage devices 425, which can include, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 400 might also include a communications subsystem 430, which can include without limitation a modem, a network card (wireless or wired), an infrared communication device, a wireless communication device, and/or a chipset such as a Bluetooth™ device, a 802.11 device, a WiFi device, a WiMax device, cellular communication facilities, etc., and/or the like. The communications subsystem 430 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 430. In other embodiments, a portable electronic device, e.g., the first electronic device, may be incorporated into the computer system 400, e.g., an electronic device as an input device 415. In some embodiments, the computer system 400 will further include a working memory 435, which can include a RAM or ROM device, as described above.

The computer system 400 also can include software elements, shown as being currently located within the working memory 435, including an operating system 460, device drivers, executable libraries, and/or other code, such as one or more application programs 465, which may include computer programs provided by various embodiments, and/or may be designed to implement methods, and/or configure systems, provided by other embodiments, as described herein. Merely by way of example, one or more procedures described with respect to the methods discussed above, such as those described in relation to FIG. 4, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 425 described above. In some cases, the storage medium might be incorporated within a computer system, such as computer system 400. In other embodiments, the storage medium might be separate from a computer system e.g., a removable medium, such as a compact disc, and/or provided in an installation package, such that the storage medium can be used to program, configure, and/or adapt a general-purpose computer with the instructions/code stored thereon. These instructions might take the form of executable code, which is executable by the computer system 400 and/or might take the form of source and/or installable code, which, upon compilation and/or installation on the computer system 400 e.g., using any of a variety of generally available compilers, installation programs, compression/decompression utilities, etc., then takes the form of executable code.

It will be apparent that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 400 to perform methods in accordance with various embodiments of the technology. According to a set of embodiments, some or all of the operations of such methods are performed by the computer system 400 in response to processor 410 executing one or more sequences of one or more instructions, which might be incorporated into the operating system 460 and/or other code, such as an application program 465, contained in the working memory 435. Such instructions may be read into the working memory 435 from another computer-readable medium, such as one or more of the storage device(s) 425. Merely by way of example, execution of the sequences of instructions contained in the working memory 435 might cause the processor(s) 410 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 400, various computer-readable media might be involved in providing instructions/code to processor(s) 410 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 425. Volatile media include, without limitation, dynamic memory, such as the working memory 435.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 410 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 400.

The communications subsystem 430 and/or components thereof generally will receive signals, and the bus 405 then might carry the signals and/or the data, instructions, etc. carried by the signals to the working memory 435, from which the processor(s) 410 retrieves and executes the instructions. The instructions received by the working memory 435 may optionally be stored on a non-transitory storage device 425 either before or after execution by the processor(s) 410.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Various aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

As used herein and in the appended claims, the singular forms “a”, “an”, and “the” include plural references unless the context clearly dictates otherwise. Thus, for example, reference to “a user” includes a plurality of such users, and reference to “the processor” includes reference to one or more processors and equivalents thereof known in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method comprising:
sending, by a user device, a content manifest request for a content item to a content provider in communication with the user device;
receiving, by the user device, a content manifest response including a content manifest file associated with the content item and an advertisement (Ad) template;
initiating, by the user device, a single player instance for playback and presentation of main content of the content item according to the content manifest file;
pausing, by the user device, the playback of the main content at a first time point, in response to a user request received in the user device;
receiving, at the user device, a thumbnail image of the main content presented at the first time point;
presenting, by the user device, the thumbnail image within the single player instance;
sending, by the user device, an Ad manifest request for a PauseAd to a dynamic manifest generator in communication with the user device;
receiving, in the user device, an Ad manifest response from the dynamic manifest generator, the Ad manifest response including an Ad manifest file and an Ad Uniform Resource Locator (URL) to the PauseAd;
fetching, by the user device, the PauseAd using the Ad URL; and
initiating, by the user device, a PauseAd streaming session for playback of the PauseAd within the single player instance, according to the Ad template and the Ad manifest file.

2. The method of claim 1, further comprising:
before receiving the thumbnail image, determining, by the user device, that a first period of time has elapsed since the pause without detecting a user interaction event to resume the playback of the main content.

3. The method of claim 1, further comprising:
before initiating, by the user device, a PauseAd streaming session, determining, by the user device, that a second period of time has elapsed since the presentation of the thumbnail image without detecting a user interaction event to stop the playback of the PauseAd.

4. The method of claim 1, further comprising:
determining, by the user device, that a third period of time has elapsed since the playback of the PauseAd without detecting a user interaction event to stop the playback of the PauseAd;
sending a second Ad manifest request for a new PauseAd to the dynamic manifest generator;
receiving, in the user device, a new Ad manifest response including a new Ad manifest file and a new Ad URL to the new PauseAd;
fetching, by the user device, the new PauseAd using the new Ad URL; and
initiating playback of the new PauseAd in the PauseAd streaming session immediately after the playback of the new PauseAd is completed, according to the Ad template and the new Ad manifest file.

5. The method of claim 1, further comprising:
presenting the thumbnail image after the playback of the PauseAd is completed;
determining, by the user device, that a fourth period of time has elapsed since the presentation of the thumbnail image without a user interaction event to resume the playback of the main content;
sending a second Ad manifest request for a new PauseAd from the user device to the dynamic manifest generator;
receiving, in the user device, a new Ad manifest response including a new Ad manifest file and a new Ad URL to the new PauseAd;
fetching, by the user device, the new PauseAd using the new Ad URL; and
initiating, by the user device, a new PauseAd streaming session for playback of the new PauseAd within the same player instance, according to the Ad template and the new Ad manifest file.

6. The method of claim 1, further comprising:
receiving, in the user device, a user request for resuming the playback of the main content;
terminating, by the user device, the PauseAd streaming session to withhold presenting the PauseAd; and
presenting, by the user device, the thumbnail image.

7. The method of claim 6, further comprising:
sending a content manifest update request from the user device to the dynamic manifest generator;
receiving, in the user device, a content manifest update response including an updated content manifest file associated with the content item; and
resuming, by the user device, the playback and presentation of the main content according to the updated content manifest file.

8. A user device comprising:
one or more processors; and
a computer-readable storage media storing computer-executable instructions that, when executed by the one or more processors, cause the user device to perform:
sending a content manifest request for a content item to a content provider in communication with the user device;
receiving a content manifest response including a content manifest file associated with the content item and an Ad template;
initiating a single player instance for playback and presentation of main content of the content item according to the content manifest file;
pausing the playback of the main content at a first time point, in response to a user request received in the user device;
receiving a thumbnail image of the main content presented at the first time point;
presenting the thumbnail image within the single player instance;
sending an Ad manifest request for a PauseAd to a dynamic manifest generator in communication with the user device;
receiving, an Ad manifest response from the dynamic manifest generator, the Ad manifest response including an Ad manifest file and an Ad URL to the PauseAd;
fetching the PauseAd using the Ad URL; and
initiating a PauseAd streaming session for playback of the PauseAd within the single player instance, according to the Ad template and the Ad manifest file.

9. The user device of claim 8, wherein the instructions when executed by the one or more processors, further cause the user device to perform:
determining that a first period of time has elapsed since the pause without detecting a user interaction event to resume the playback of the main content, before receiving the thumbnail image.

10. The user device of claim 8, wherein the instructions when executed by the one or more processors, further cause the user device to perform:
determining that a second period of time has elapsed since the presentation of the thumbnail image without detecting a user interaction event to stop the playback of the PauseAd, before initiating the PauseAd streaming session.

11. The user device of claim 8, wherein the instructions when executed by the one or more processors, further cause the user device to perform:
determining that a third period of time has elapsed since the playback of the PauseAd without detecting a user interaction event to stop the playback of the PauseAd;
sending a second Ad manifest request for a new PauseAd to the dynamic manifest generator;
receiving a new Ad manifest response including a new Ad manifest file and a new Ad URL to the new PauseAd;
fetching the new PauseAd using the new Ad URL; and
initiating playback of the new PauseAd in the PauseAd streaming session immediately after the playback of the new PauseAd is completed, according to the Ad template and the new Ad manifest file.

12. The user device of claim 8, wherein the instructions when executed by the one or more processors, further cause the user device to perform:
presenting the thumbnail image after the playback of the PauseAd is completed;
determining that a fourth period of time has elapsed since the presentation of the thumbnail image without a user interaction event to resume the playback of the main content;
sending a second Ad manifest request for a new PauseAd from the user device to the dynamic manifest generator;
receiving a new Ad manifest response including a new Ad manifest file and a new Ad URL to the new PauseAd;
fetching the new PauseAd using the new Ad URL; and
initiating a new PauseAd streaming session for playback of the new PauseAd within the same player instance, according to the Ad template and the new Ad manifest file.

13. The user device of claim 8, wherein the instructions when executed by the one or more processors, further cause the user device to perform:
receiving a user request for resuming the playback of the main content;
terminating the PauseAd streaming session to stop presenting the PauseAd; and
presenting, immediately after terminating the PauseAd streaming session, the thumbnail image.

14. The user device of claim 13, wherein the instructions when executed by the one or more processors, further cause the user device to perform:
sending a content manifest update request to the dynamic manifest generator;
receiving a content manifest update response including an updated content manifest file associated with the content item; and
resuming the playback and presentation of the main content according to the updated content manifest file.

15. A system comprising:
a user device;
a dynamic manifest generator;
an Ad template generator; and
a thumbnail image generator;
wherein the user device is configured to:
send a content manifest request for a content item to the dynamic manifest generator;
receive a content manifest response generated by the dynamic manifest generator and an Ad template generated by the Ad template generator, wherein the content manifest response includes a content manifest file associated with the content item;
initiate a single player instance for playback and presentation of main content of the content item according to the content manifest file;
pause the playback of the main content at a first time point, in response to a user request received in the user device;
receive a thumbnail image generated by the thumbnail image generator, the thumbnail image representing the main content presented at the first time point;
present the thumbnail image within the single player instance;
send an Ad manifest request for a PauseAd to the Ad manifest generator;
receive an Ad manifest response generated by the Ad manifest generator, the Ad manifest response including an Ad manifest file and an Ad URL to the PauseAd;
fetch the PauseAd using the Ad URL; and
initiate a PauseAd streaming session for playback of the PauseAd within the single player instance, according to the Ad template and the Ad manifest file.

16. The system of claim 15, wherein the user device is further configured to:
determine that a first period of time has elapsed since the pause without detecting a user interaction event to resume the playback of the main content, before receiving the thumbnail image.

17. The system of claim 15, wherein the user device is further configured to:
determine that a second period of time has elapsed since the presentation of the thumbnail image without detecting a user interaction event to stop the playback of the PauseAd, before initiating the PauseAd streaming session.

18. The system of claim 15, wherein the user device is further configured to:
determine that a third period of time has elapsed since the playback of the PauseAd without detecting a user interaction event to stop the playback of the PauseAd;
send a second Ad manifest request for a new PauseAd to the dynamic manifest generator;
receive a new Ad manifest response generated by the dynamic manifest generator, the new Ad manifest response including a new Ad manifest file and a new Ad URL to the new PauseAd;
fetch the new PauseAd using the new Ad URL; and
initiate playback of the new PauseAd in the PauseAd streaming session immediately after the playback of the new PauseAd is completed, according to the Ad template and the new Ad manifest file.

19. The system of claim 15, wherein the user device is further configured to:
present the thumbnail image after the playback of the PauseAd is completed;
determine that a fourth period of time has elapsed since the presentation of the thumbnail image without a user interaction event to resume the playback of the main content;
send a second Ad manifest request for a new PauseAd to the dynamic manifest generator;
receive a new Ad manifest response generated by the dynamic manifest generator, the new Ad manifest response including a new Ad manifest file and a new Ad URL to the new PauseAd;
fetch the new PauseAd using the new Ad URL; and
initiate a new PauseAd streaming session for playback of the new PauseAd within the same player instance, according to the Ad template and the new Ad manifest file.

20. The method of claim 1, wherein the user device is further configured to:
receive a user request for resuming the playback of the main content;
terminate the PauseAd streaming session to withhold presenting the PauseAd; and
present, immediately after terminating the PauseAd streaming session, the thumbnail image.
